(19) United States
(12) Patent Application Publication
(10) Pub. No.: US 2022/0078203 A1
(43) Pub. Date: Mar. 10, 2022

(54) SYSTEMS AND METHODS FOR VULNERABILITY-BASED CYBER THREAT RISK ANALYSIS AND TRANSFER

(71) Applicant: Cyber Reconnaissance, Inc., Tempe, AZ (US)

(72) Inventors: Paulo Shakarian, Tempe, AZ (US); Jana Shakarian, Tempe, AZ (US); Kazuaki Kashihara, Tempe, AZ (US)

(21) Appl. No.: 17/201,869

(22) Filed: Mar. 15, 2021

Related U.S. Application Data
(60) Provisional application No. 62/989,395, filed on Mar. 13, 2020.

(51) Int. Cl. H04L 29/06; G06Q 10/06; G06F 16/951

(52) U.S. Cl. CPC H04L 63/1433; G06F 16/951; G06Q 10/06393

(57) ABSTRACT

A computing device configured for predictive functions related to cyber threat risk accesses historical cybersecurity event data that lists past attacks on particular companies in different industry vertical classifications. Using vulnerability data associated with each attack, enhanced by metadata specifying vulnerable hardware and/or software stacks associated with the attacks, exemplary technology configurations are created that map industry vertical classifications to vulnerable hardware and/or software stacks. These exemplary technology configurations are used as bases for comparison to subject technology configurations under evaluation. A comparison of a subject technology configuration parameters to parameters of the plurality of exemplary technology configurations can reveal similarities that indicate that the subject technology configuration is vulnerable one or more same threats that the exemplary technology configurations are known to be vulnerable to or that the subject technology configuration is susceptible to heightened cyber threat risk, based on historical cybersecurity event data.

### CROSS REFERENCE TO RELATED APPLICATIONS

This application claims benefit to U.S. provisional patent application Ser. No. 62/989,395, filed on Mar. 13, 2020, which is incorporated by reference in entirety.

### FIELD

The present disclosure generally relates to predictive cyber technologies; and in particular, to systems and methods for vulnerability-based risk transfer for cyber security.

### BACKGROUND

An increasing number of software (and hardware) vulnerabilities are discovered and publicly disclosed every year. In 2016 alone, more than 10,000 vulnerability identifiers were assigned and at least 6,000 were publicly disclosed by the National Institute of Standards and Technology (NIST). Once the vulnerabilities are disclosed publicly, the likelihood of those vulnerabilities being exploited increases. With limited resources, organizations often look to prioritize which vulnerabilities to patch by assessing the impact it will have on the organization if exploited. Standard risk assessment systems such as Common Vulnerability Scoring System (CVSS), Microsoft Exploitability Index, Adobe Priority Rating report many vulnerabilities as severe and will be exploited to err on the side of caution. This does not alleviate the problem much since the majority of the flagged vulnerabilities will not be attacked.

NIST provides the National Vulnerability Database (NVD) which comprises of a comprehensive list of vulnerabilities disclosed, but only a small fraction of those vulnerabilities (less than 3%) are found to be exploited in the wild—a result confirmed in the present disclosure. Further, it has been found that the CVSS score provided by NIST is not an effective predictor of vulnerabilities being exploited.

It is with these observations in mind, among others, that various aspects of the present disclosure were conceived and developed.

### BRIEF DESCRIPTION OF THE DRAWINGS

FIG. 1 is a simplified block diagram showing a computer-implemented system for vulnerability-based risk transfer of cyber security.

FIG. 2 is a simplified block diagram of a possible computer-implemented method of applying aspects of the system of FIG. 1 for vulnerability-based risk transfer of cyber security.

FIG. 3A is an illustration of an embodiment of the system described herein configured for mapping a technology configuration to one or more vulnerabilities.

FIG. 3B is a simplified block diagram illustrating further aspects of the embodiment of FIG. 3A.

FIG. 3C is an illustration related to the embodiment of FIG. 3A illustrating database mapping benefits provided by present disclosure.

FIG. 3D is a simplified block diagram of a possible computer-implemented method/process of creating exemplary technology configurations related to the embodiment of FIG. 3A.

FIG. 4A is an illustration showing use of exemplary technology configurations such as exemplar technology stacks to analyze threats to portfolio companies.

FIG. 4B is a simplified block diagram illustrating further aspects of the embodiment of FIG. 4A.

FIG. 4C is an illustration related to the embodiment of FIG. 4A illustrating database mapping benefits provided by present disclosure.

FIG. 4D is a simplified block diagram of a possible computer-implemented method of mapping predicted threats to software and/or hardware configurations.

FIG. 5A is an illustration of a comparison between a company's risk posture to an exemplary technology configuration such as an exemplar technology stack.

FIG. 5B is a simplified block diagram of a possible computer-implemented method of quantifying vulnerabilities of one or more technology stacks for vulnerability-based cyber risk transfer.

FIG. 6 is an illustration of consideration of various options to reduce risk based on relative changes when compared to an exemplary technology configuration such as an exemplar technology stack.

FIG. 7 is an example simplified schematic diagram of a computing device that may implement various methodologies described herein.

Corresponding reference characters indicate corresponding elements among the view of the drawings. The headings used in the figures do not limit the scope of the claims.

### DETAILED DESCRIPTION

Aspects of the present disclosure relate to a computer-implemented system and associated methods for vulnerability-based cyber risk transfer to improve cyber security. In particular, a computer-implemented system (“system”) is disclosed that accesses cybersecurity/cyber threat information (to include, but not limited to information about threats) from various sources including the deep web, dark web, social media, open Internet and/or private or proprietary data sources. In general, this information is then processed as described to map, or generate mappings of technology configurations, such as exemplary technology stacks, to one or more vulnerabilities. Each mapping generated may define a predicted level of risk that a vulnerability will be exploited for whatever reason. In addition, exemplary technology configurations may be compared with new/different or “subject” technology configurations to assess possible vulnerabilities to the subject technology configuration. In general, the following embodiments provide a technical improvement to cyber security including cyber threat patching and prioritization, and are further responsive to the various technical challenges associated with threat assessment and response.

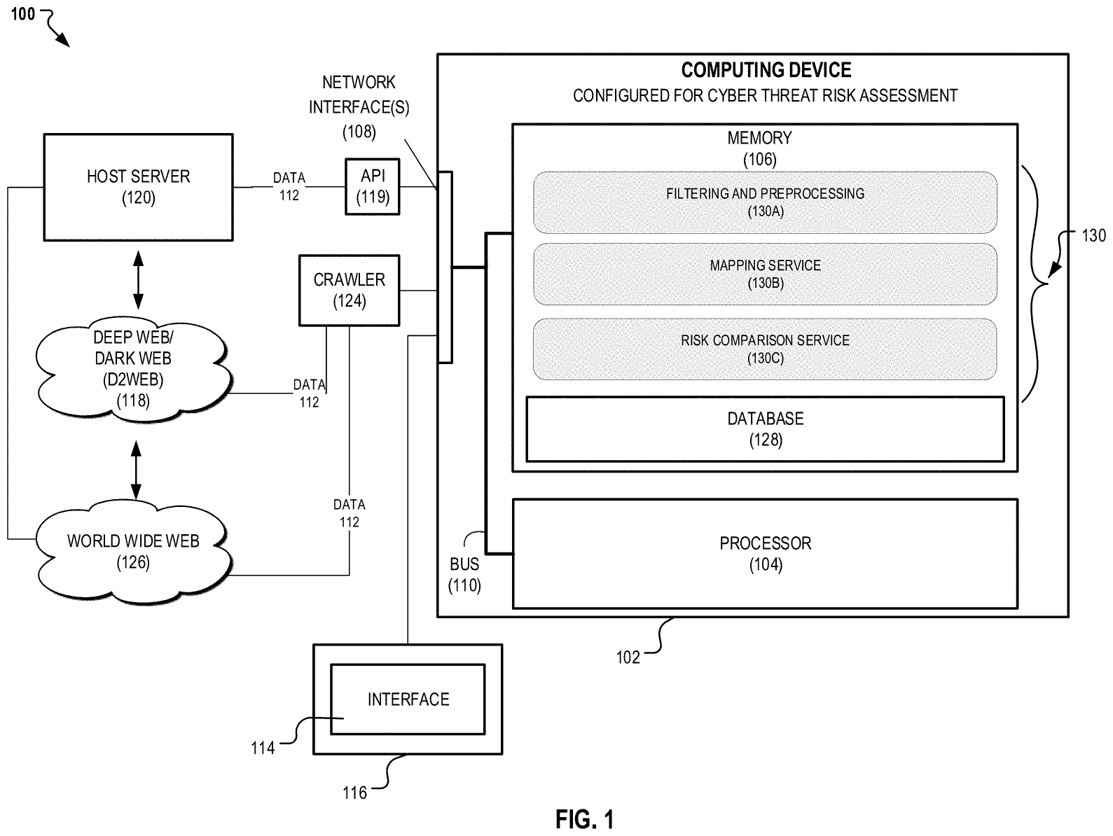

Referring to FIG. 1, any of the aforementioned embodiments of a system described herein may take the form of a computer-implemented system, designated system 100, which may be utilized for vulnerability-based cyber risk transfer. In general, the system 100 comprises a computing device 102 including a processor 104, a memory 106 of the computing device 102 (or separately implemented), a network interface (or multiple network interfaces) 108, and a bus 110 (or wireless medium) for interconnecting the aforementioned components. The network interface 108 includes the mechanical, electrical, and signaling circuitry for communicating data over links (e.g., wires or wireless links) within a network (e.g., the Internet). The network interface 108 may be configured to transmit and/or receive data using a variety of different communication protocols, as will be understood by those skilled in the art.

As indicated, via the network interface 108 or otherwise, the computing device 102 is adapted to access cybersecurity and/or cyber threat data (hereinafter data 112) from a host server 120 which may be stored/aggregated within a storage device (not shown) or locally stored within the memory 106. The data 112 includes any information about cybersecurity events across multiple technology platforms referenced herein, information about known vulnerabilities associated with hardware and software components exploited during the cybersecurity events or otherwise, and may further include, without limitation, information gathered regarding possible hardware and software components/parameters being implemented by a given technology configuration (e.g., hardware and/or software) associated with a company. The data 112 may originate from sources including the deep web, dark web, social media, open Internet and/or private or proprietary data sources.

As shown, the computing device 102 is adapted, via the network interface 108 or otherwise, to access the data 112 from any number or type of sources, such as the deep or dark web, collectively “D2web” 118, and/or the World Wide Web 126. The dark web of the D2web 118, sometimes referred to as deep web, can refer to interconnected networks of computers accessible by the Internet, but that require specific software, configurations, or authorization to access. In some embodiments, the computing device 102 accesses the data 112 by engaging an application programming interface 119 to establish a temporary communication link with the host server 120. Alternatively, or in combination, the computing device 102 may be configured to implement a crawler 124 (or spider or the like) to extract data from the D2web 118 without aid of a separate device (e.g., host server 120). In some embodiments, host server 120 executes specific software, holds a specific configuration, or is capable of providing specific authorization to aid in accessing D2web 118. In some embodiments, computing device 102, crawler 124, or API 119 access D2web 118 using (or, with the aid of) the specific software, configuration, or authorization provided by host server 120. Further, the computing device 102 may access the data 112 from the general Internet or World Wide Web 126 as needed, with or without aid from the host server 120.

The data 112 may define any number of datasets and may be aggregated or accessed by the computing device 102 may be stored within a database 128. Once the data 112 is accessed and/or at least temporarily stored in the database 128, the processor 104 is operable to execute a plurality of services 130 to apply one or more functions to the data 112 or to leverage the data in some form so as to determine correlations, generate mappings, and/or generate rules or predictive functions, as further described herein. The services 130 of the system 100 may include, without limitation, a filtering and preprocessing service 130A for, in general, preparing the data 112 for machine learning or further use. Services 130 further include a mapping service 130B for mapping an exemplary technology configuration or exemplary technology stack (ETS), which may include one or more specific hardware and/or software configurations, with one or more vulnerabilities based on the data 112 and also for identifying commonalities between separate technology configurations or stacks. Services 130 also include a cyber-risk comparison service 130C that compares a given technology configuration (e.g., an implemented hardware and/or software configuration under evaluation) with an ETS to assess possible risk of a possible cyber-attack to the given technology configuration, as further described herein. The plurality of services 130 may include any number of components or modules executed by the processor 104 or otherwise implemented. Accordingly, in some embodiments, one or more of the plurality of services 130 may be implemented as code and/or machine-executable instructions executable by the processor 104 that may represent one or more of a procedure, a function, a subprogram, a program, a routine, a subroutine, a module, an object, a software package, a class, or any combination of instructions, data structures, or program statements, and the like. In other words, one or more of the plurality of services 130 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 106), and the processor 104 performs the tasks defined by the code.

As shown, the system 100 may further provide a portal or interface (e.g., 114) executable by a remote computing device (e.g., computing device 116 that can be remote relative to computing device 102) that may be leveraged to facilitate comparison of an exemplary technology configuration or stack (ETS) to a new or different/subject technology configuration such as a software or hardware platform associated with some entity, or a configuration of hardware and/or software that is implemented by a client. In this manner, for example, possible commonalities between a new, subject, given, or pre-evaluation technology configuration and an exemplary technology configuration can be evaluated so as to inform about possible vulnerabilities to the new technology configuration already known to be relevant to the exemplary technology configuration. For example, where an exemplary technology configuration/stack has been mapped to a vulnerability V, and a new technology configuration/stack under computer analysis is similar to or shares some aspects of the exemplary technology configuration/stack, the computing device 102 informs that the new technology configuration/stack is likely to be or is already exposed to the vulnerability V in some form.

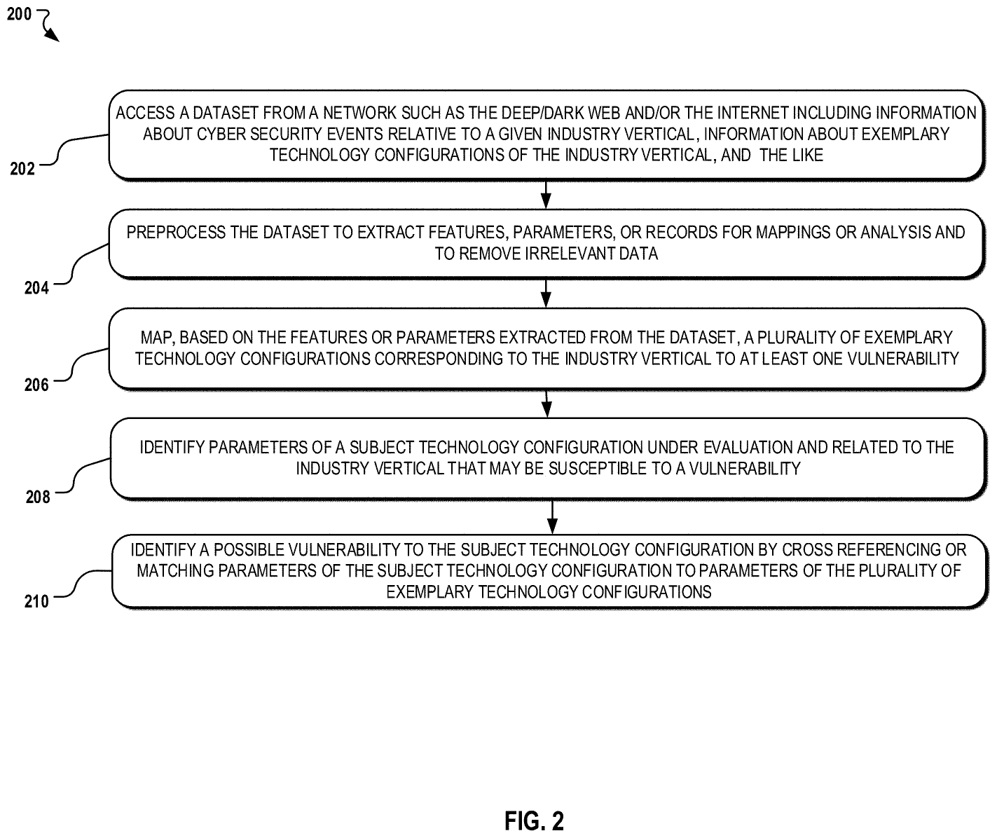

Referring now to a process flow diagram 200 of FIG. 2, aspects of the plurality of services 130 and a general implementation of the system 100 shall now be described. Referring to block 202, a dataset, or any number datasets of the data 112 may be accessed, collected, or acquired. As mentioned above in connection with FIG. 1, data 112 includes cybersecurity event data and/or vulnerabilities associated with particular technology configurations (e.g., particular configurations of hardware and/or software). As such, the dataset may include information from, by non-limiting examples, dark web forums, blogs, marketplaces accessed via D2web 118, intelligence threat APIs, data leaks, data dumps, the general Internet or World Wide Web 126, and the like, and may be acquired using web crawling (e.g., via crawler 124, when computing device 102 acquires the cybersecurity event data without the aid of a separate device such as host server 120), RESTful HTTP requests, HTML parsing, or any number or combination of such methods.

In one specific embodiment, using the API 119, the dataset may be acquired from a remote database hosted by, e.g., host server 120. In this embodiment, the host server 120 gathers D2web or deep/dark web data from any number of D2web sites or platforms accessible via D2web 118, and makes the data accessible to other devices over the Internet or the World Wide Web 126. More particularly, the computing device 102 issues an API call to the host server 120 using the API 119 to establish a RESTful Hypertext Transfer Protocol Secure (HTTPS) connection over the Internet or World Wide Web 126. Then, the data 112 can be transmitted to the computing device 102 in an HTTP response with content provided in key-value pairs (e.g., JSON).

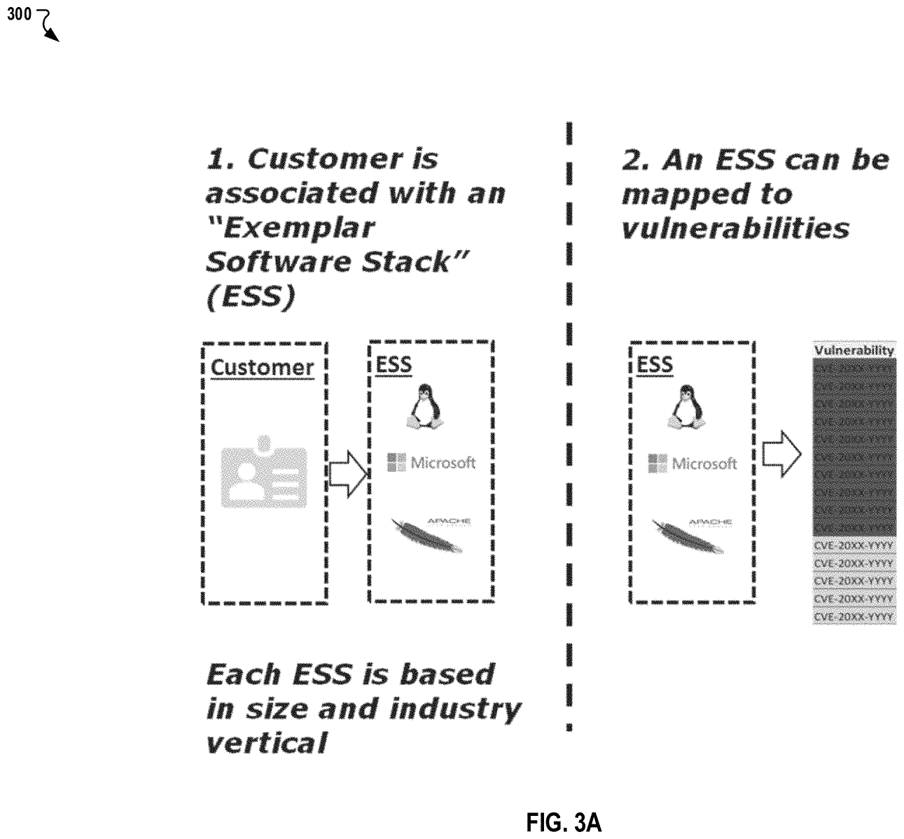

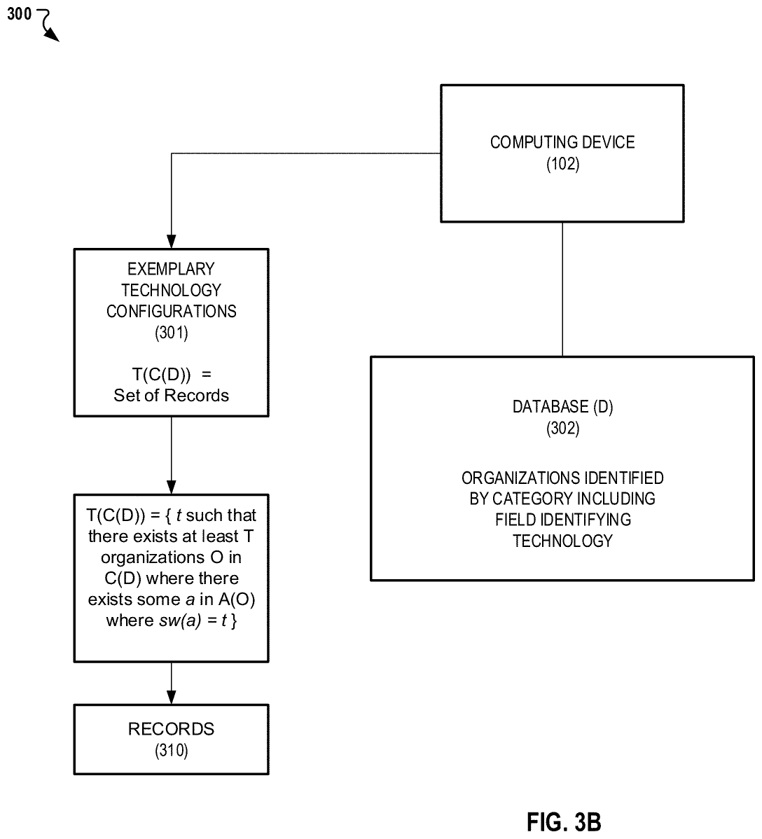

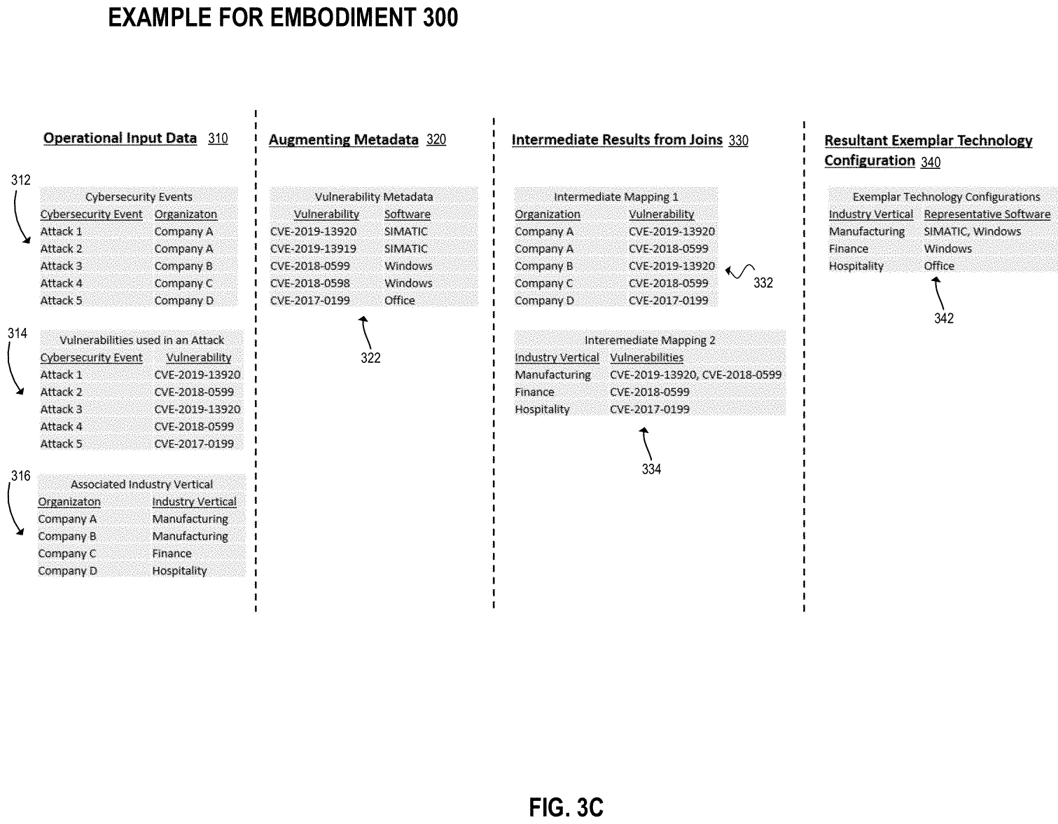

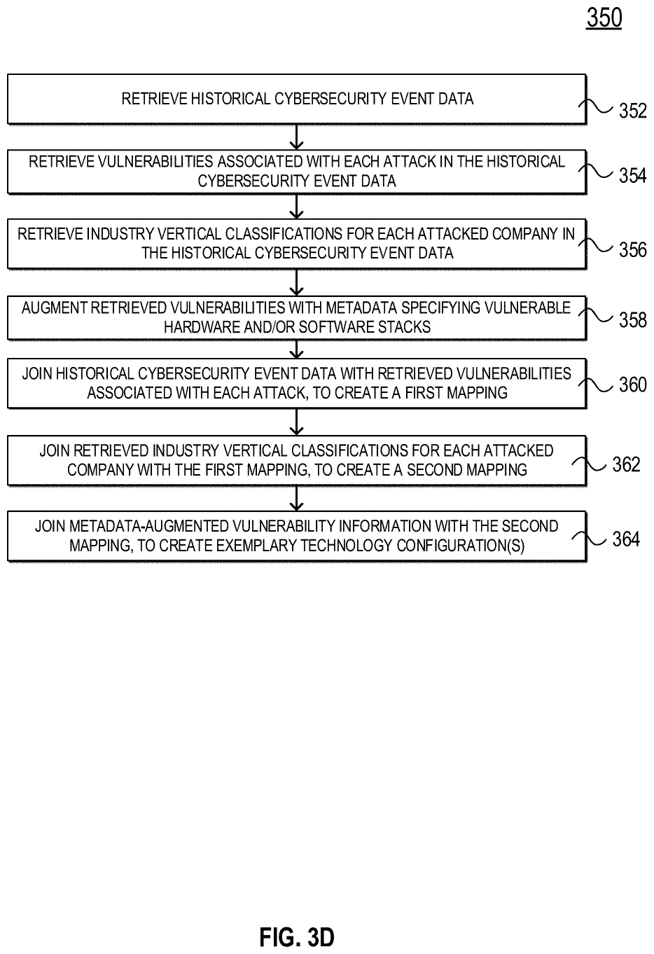

Referring to block 204 and the filtering and preprocessing service 130A executable by the computing device 102, the dataset may be preprocessed by, e.g., cleaning the dataset in some form, filtering the dataset, changing the format of the dataset, or modeling the dataset in some predetermined fashion. For example, in some embodiments, the dataset may be processed by applying text translation, topic modeling, content tagging, social network analysis, or any number or combination of artificial intelligence methods. Any of such data cleaning techniques can be used to filter content of the dataset from other content commonly discussed in the D2web 118 such as drug-related discussions or pornography, and to format the data 112 as desired. In some embodiments, the present step of block 204 results, by the processor 104 in the extraction of parameters or features (e.g., as shown in FIG. 3C operational input data such as attack records and corresponding company configurations, cyber attack records and associated vulnerabilities, information linking companies to an industry vertical, metadata, and the like) from the data 112, and the parameters or features can be mapped together in some form, or used to form records of a database, as further described herein.

Referring to block 206, the processor 104 may execute the mapping service 130B to identify one or more exemplary technology configurations from the dataset based on a predetermined size and/or predetermined industry vertical, and then map the exemplary technology configurations to at least one vulnerability known to affect one or more of the exemplary technology configurations. For example, a given one of the exemplary technology configurations of an industry vertical may define a computing environment running Windows Server 2008 on an IBM computing device, and it may be discovered via the dataset that such an exemplary technology configuration is susceptible or vulnerable to a Attack Vector V (which may include, for example, malware, exploits, the known use of common system misconfigurations, or other attack methodology), based on e.g., historical cyber-attacks.

Referring to blocks 208 and 210, the processor 104 may further execute functionality from the mapping service 130B and the comparison service 130C to (i) identify parameters of a subject technology configuration that needs to be analyzed for whatever reason, and (ii) determine possible risk to the subject technology configuration (based on what is already know from the attack vector V and one or more exemplary technology configurations). For example, the leveraging data mining or other means, the processor 104 may access information that a developer associated with the subject technology configuration has visited an IBM-related blog website, and inquired about Windows Server 2008, such that it may be assumed that the subject technology configuration at least includes an IBM device running Windows Server 2008. Accordingly, the processor 104 as configured may then extrapolate further and indicate that the subject technology configuration should be assigned some risk indication that the configuration could be affected by the Attack Vector V. The aforementioned is intended to merely describe a general computer-implemented system and method of leveraging vulnerabilities of a given industry vertical to assess cyber risk to a subject technology configuration associated with the industry vertical. Additional embodiments and sub-embodiments shall now be provided.

### Exemplary Embodiments of the System (100)

Referring to the aforementioned and FIG. 3A, in one embodiment 300 of the system 100, the system 100 is configured to create representative or exemplary technology (e.g., software or hardware) configurations 301 for an industry vertical based on an attack or vulnerability. In this embodiment generally, the system 100 takes as input a data source including information about cybersecurity attacks or events across known technology configurations from multiple companies, information about a corresponding industry vertical associated with the victim of the attacks related to the known technology configurations (i.e. identifiable by NAICS code), a list of software and/or hardware vulnerabilities exploited by hackers or otherwise used in the attacks, and the date of the attack. As an alternative, lists of vulnerabilities across multiple companies within an industry vertical could also be used (e.g., from a vulnerability scanner or a service provider that served multiple firms across multiple verticals). From this information, over the course of a predetermined period of time (e.g., 1 year), for a given industry vertical, the system 100 produces a list of software vulnerabilities (i.e. identifiable by the National Institute of Standards and Technology (NIST) common vulnerability enumeration (CVE) numbers, for instance) used against firms within the subject industry vertical as well as the associated software or hardware (i.e. identifiable by NIST common platform enumeration (CPE) numbers, for instance) relating to the vulnerability.

As shown in FIG. 3B and FIG. 3C, an example implementation of the embodiment 300 is as follows (and processor 104 is configured with computer-executable instructions to perform at least some aspects of the same):

i. A database D 302 is accessed or generated by the computing device 102, where the database D 302 comprises information about technology configurations (hardware and software) of subject organizations identified by a desired categorization (i.e. industry vertical). Associated with each of the subject organizations is a set of cybersecurity attack incident records and/or vulnerability records; the time period for such records being the same across all organizations catalogued in D. For a given organization O in D, the notation A(O) may be applied to denote the associated vulnerability or attack records.
ii. It is assumed in this example that the vulnerability and/or attack records associated with organization O in D (set A(O)) have a field identifying the technology leveraged (or could be leveraged) by a potential threat actor in the attack or against the vulnerability. For example, the technology could be software or hardware used within the organization in question. Hence, for a given record a in set A(O), we can say sw(a) is the associated technology. Note that this association can be set at different levels of granularity based on the vendor, version, build and/or patch level of the technology (i.e. Microsoft Windows vs. Microsoft Windows 10 vs. Microsoft Windows 10 Pro Build 1909). It can further be assumed for the sake of simplicity that the level of granularity is set by the user of the system and can be changed for each the precise application.
iii. By the (processor 104) computing device 102, using machine learning, regular expression matching, or queries to another database, each sw(a) can be normalized across every record in A(O) for every O in set D. This is often a necessary step, especially if D is created from a variety of different sources. Throughout what follows, we shall assume that sw(a) is normalized using such techniques.
iv. For a given category of organizations, denoted C, let C(D) be all the organizations of that category in database D. Note that the categorization can depend on one or more factors such as industry vertical, organization size, geographic location, etc.
v. We then create a set of records of the exemplary technology configurations 301 associated with the organizations in C(D). As such, the set of records would include any technology associated with at least a certain number of organizations in C(D) (defined by a threshold T). Formally, we can compute and denote this set of records as T(C(D)) and define it for threshold T as follows:
   T(C(D))={t such that there exists at least T organizations O in C(D) where there exists some a in A(O) where sw(a)=t}.

Turning to FIG. 3C, some of the data sets mentioned above and their transformations into different data sets or records by computing device 102, are illustrated with exemplary values. In some embodiments, the data set transformations illustrated using the exemplary values shown in FIG. 3C are performed by filtering and preprocessing services 130A and mapping service 130B (sometimes referred to collectively as services 130, for simplicity), both of which are stored in memory 106 and executed by the processor 104 as described in connection with FIG. 1.

In the first column of FIG. 3C, operational input data 310 is retrieved by the processor 104 executing one or more of the services 130. Operational input data 310 includes historical cybersecurity event data 312, represented as a table or data set specifying particular attacks, the attacked companies (as shown in FIG. 3C), in addition to other attributes of the attacks not illustrated in FIG. 3C such as the date of each attack or its severity. Cybersecurity event data 312 is sometimes referred to as attack incident records. Referencing the notation introduced above, the cybersecurity event data may be attack records A(O) for a particular set of organizations O within the database D. With reference to the exemplary values in FIG. 3C, the organizations O include Company A, Company B, Company C, and Company D. In certain embodiments, cybersecurity event data shown in FIG. 3C is retrieved from cyber event information of the data 112 that is stored and updated at host server 120.

Below the historical cybersecurity event data 312 illustrated by FIG. 3C, vulnerabilities 314 associated with each attack in the historical cybersecurity event data are shown. Vulnerabilities 314 may include a list of software vulnerabilities (identifiable by the National Institute of Standards and Technology (NIST) common vulnerability enumeration (CVE) numbers) or hardware vulnerabilities (not shown in the exemplary values, but identifiable by NIST common platform enumeration (CPE) numbers, for instance) relating to the particular attacks in the attack records A(O). Taking a set V(A) to represent all the vulnerabilities associated with attack records A, the vulnerabilities 314 associated with each attack in the historical cybersecurity event data can be represented as V(A(0)), using the notation referenced above.

Below the listings of vulnerability 314 associated with attack records for the organizations, industry vertical classifications 316 for each attacked company in the historical cybersecurity event data 312 are shown and can be computed by the processor 104 as configured. Referencing the notation above, the industry vertical classifications 316 can be represented by C(O), where O are the organizations whose historical cybersecurity events are under evaluation.

The second column 320 of FIG. 3C illustrates metadata-augmented vulnerability data 322 produced by adding metadata to the list of vulnerabilities V(A(O)) associated with the attack records A(O).

The third column 330 of FIG. 3C illustrates intermediate mappings before the creation of an exemplary technology configuration for detecting vulnerable software and/or hardware stacks in industry vertical categories or classifications. The first table 332 in the third column 330 of FIG. 3C maps companies, such as the organizations O, to vulnerabilities V(A(O)). The second table 334 in the third column 330 of FIG. 3C maps industry vertical categories or classifications C(O) to vulnerabilities V(A(O)).

The fourth column 340 of FIG. 3C illustrates resultant exemplary technology configurations 342, similar to the exemplary technology configuration referenced in connection with step 210 of FIG. 2. The resultant exemplary technology configurations 342 shown in FIG. 3C can be viewed as mappings between specific industry vertical categories or classifications C(O) of the organizations to representative software or hardware. These exemplary technology configurations can themselves be mapped to particular threats that are known to affect the software and/or hardware stacks used by organizations in the industry vertical categories or classifications. In other words, the “representative software” column of the exemplary technology configurations can describe hardware and/or software stacks associated with industry vertical categories/classifications, and thereby allow for comparison to subject technology configurations (e.g., particular combinations of hardware and/or software stacks under evaluation), such as those described in connection with blocks 208 and 210 of FIG. 2.

FIG. 3D illustrates a simplified block diagram of a possible computer-implemented process 350 of creating exemplary technology configurations based in size and corresponding to an industry vertical, which can be mapped to associated vulnerabilities, in connection with the embodiment 300 of the system 100. The process 350 can be performed by the computing device 102; e.g., the processor 104 may be configured to execute the functions of the process 350 described herein

Process 350 includes step 352, where, as described above, computing device 102 retrieves historical cybersecurity event data such as event information of the data 112 stored and maintained by host server 120, represented as a table of historical cybersecurity event data 312 in connection with FIG. 3C. As described above, a table of historical cybersecurity event data 312 can include a data set specifying particular attacks, the attacked companies (as shown in FIG. 3C), in addition to other attributes of the attacks not illustrated in FIG. 3C such as the date of each attack or its severity.

Process 350 further includes step 354, where computing device 102 retrieves vulnerabilities 314 associated with each attack in the historical cybersecurity event data 312. Vulnerabilities 314 may include a list of software vulnerabilities (each associated with a CVE number) or hardware vulnerabilities (each associated with a CPE numbers) relating to the particular attacks in the attack records of historical cybersecurity event data 312. Taking a set V(A) to represent all the vulnerabilities associated with attack records A, the vulnerabilities 314 associated with each attack in the historical cybersecurity event data can be represented as V(A(O)), using the notation referenced above.

Process 350 continues to step 356, where computing device 102 retrieves industry vertical classifications 316 for each attacked company in the historical cybersecurity event data 312. Industry vertical classifications 316 allow the configurations associated with each historical cybersecurity attack to be classified with a representative category or classification that subject technology configurations can be compared to, as a parameter (e.g., in step 210 of FIG. 2). Referencing the notation above, the industry vertical classifications 316 can be represented by C(O), where O are the organizations whose historical cybersecurity events are under evaluation.

Process 350 continues to step 358, where retrieved vulnerabilities 314 are augmented with metadata specifying vulnerable hardware and/or software stacks. As mentioned above, vulnerabilities 314 may be associated with a CVE or CPE number. At step 358, vulnerabilities 314 associated with a particular CVE number may be augmented with metadata specifying the name or other details of actual vulnerable software or software configurations associated with the particular CVE number. Similarly, vulnerabilities 314 associated with a particular CPE number may be augmented with metadata specifying the name or other details of actual vulnerable hardware or hardware configurations associated with the particular CPE number. Augmenting the vulnerabilities 314 with the metadata specifying actual configurations associated with the CVE/CPE numbers for each vulnerability produces metadata-augmented vulnerability data 322.

Process 350 Further includes step 360, where historical cybersecurity event data 312 is joined with retrieved vulnerabilities 314 associated with each attack, to create a first mapping such as the first table 332 in the third column 330 of FIG. 3C. Historical cybersecurity event data 312 that contains attack records A(O) for organizations O is joined with vulnerabilities V(A(O)) to produce a mapping of the organizations O with the vulnerabilities V(A(O)) in the first table 332.

Process 350 further includes step 362, where retrieved industry vertical classifications 316 are joined with the first mapping (e.g., first table 332) to create a second mapping (e.g., second table 334 in the third column 330 of FIG. 3C). The first mapping, between organizations O and vulnerabilities V(A(O)) are joined with the industry classification C(O), for each organization O, to generate a mapping of industry vertical categories or classifications C(O) to vulnerabilities V(A(O)) in the second table 334.

Process 350 further includes step 364, where metadata-augmented vulnerability data 322 is joined with the second mapping or second table 334, to create an exemplary technology configuration. Metadata-augmented vulnerability data 322 maps vulnerabilities V(A(O)) to particular hardware/software configurations associated with the respective vulnerability identifier (e.g., a CVE/CPE number). Joining metadata-augmented vulnerability data 322 with the second mapping or second table 334, which maps industry vertical categories or classifications C(O) to vulnerabilities V(A(O)) in the form of their vulnerability identifier, produces a mapping between industry vertical categories or classifications C(O) to the particular hardware/software configurations associated with the vulnerability identifier (e.g., T(C(O)), using the notation used above). Such mappings are referred to as exemplary technology configurations 342.

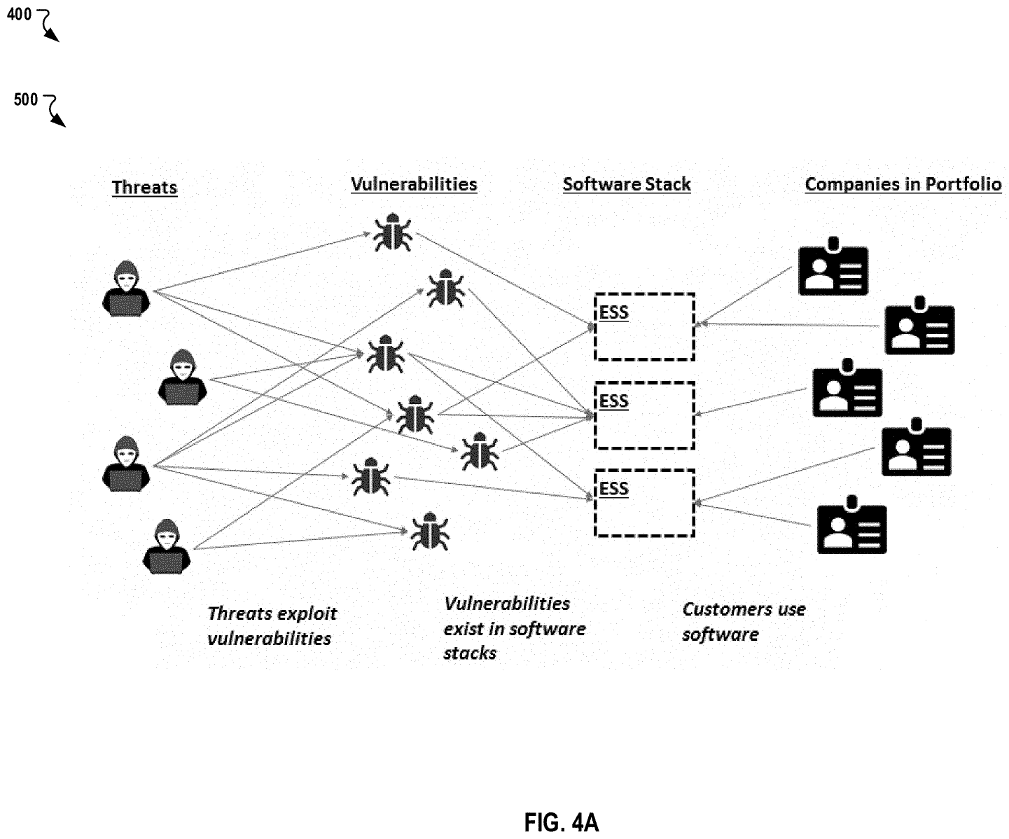

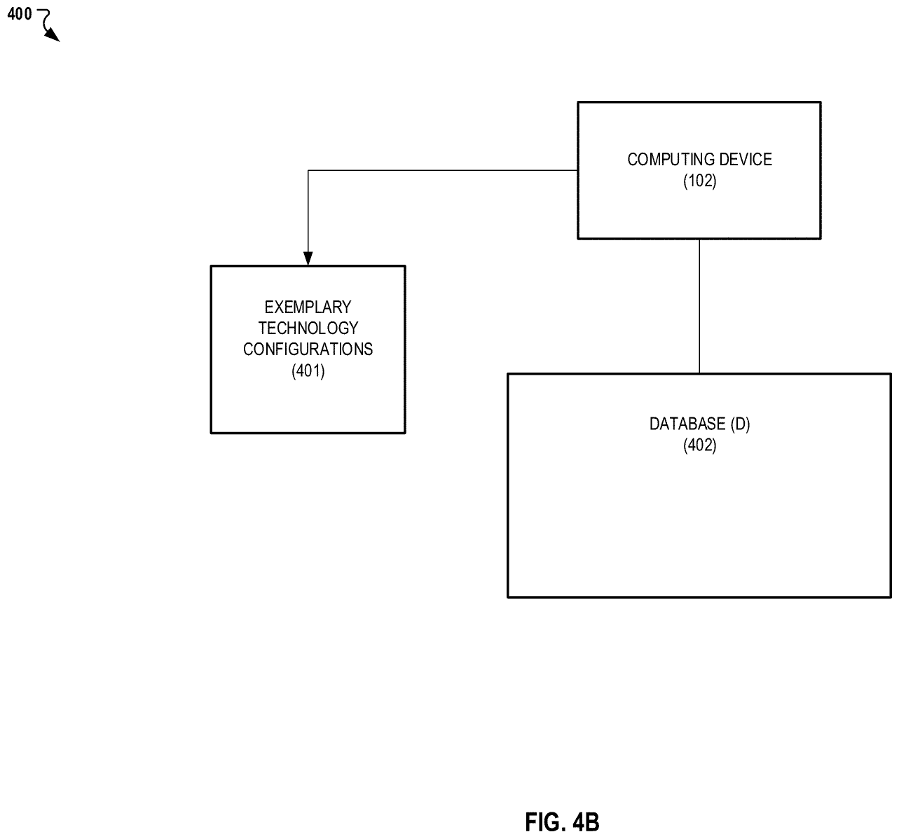

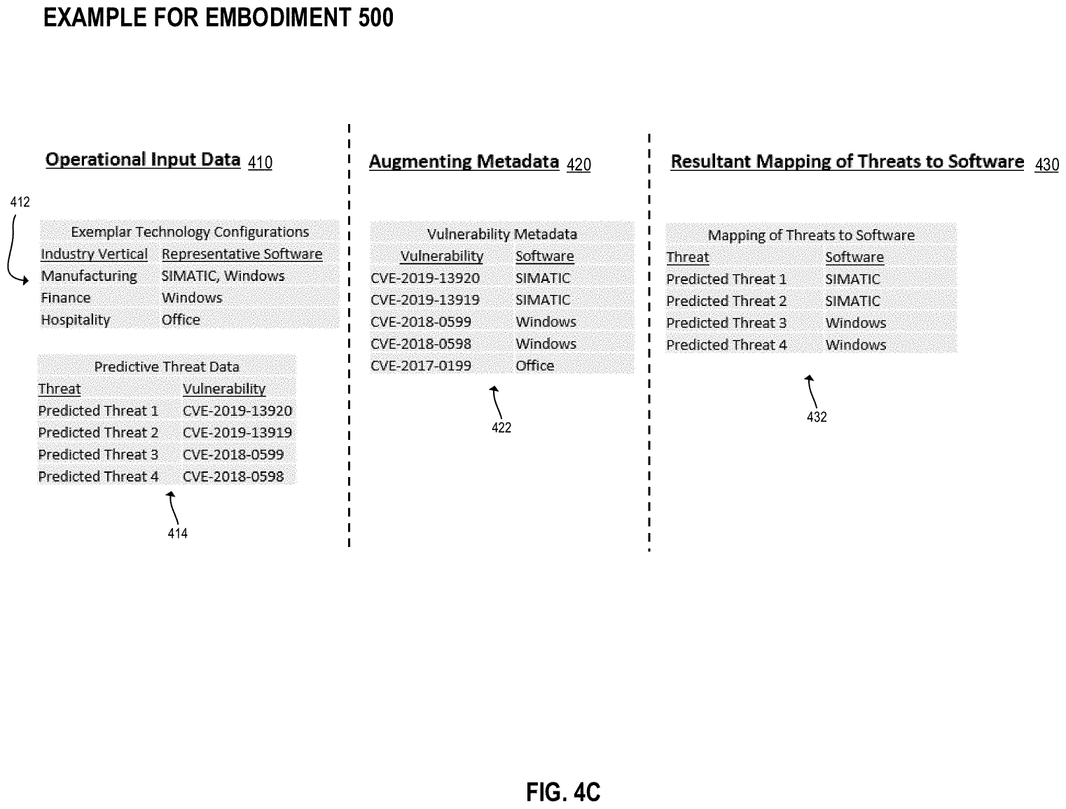

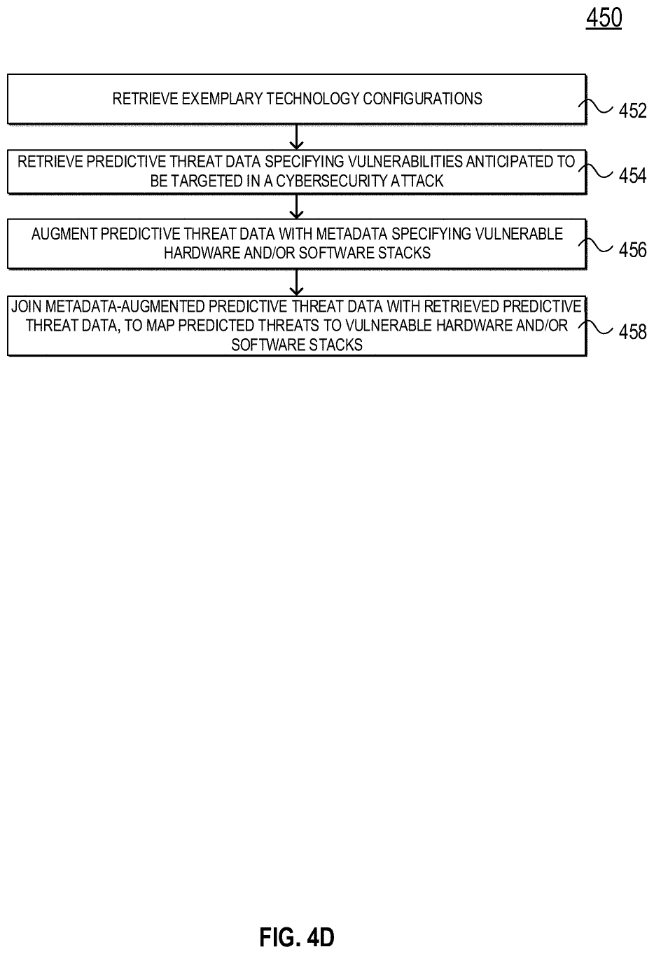

Referencing FIGS. 4A and 4B, in another embodiment 400, the system 100 creates representative or exemplary technology configurations 401 such as software configurations for an industry vertical based on aggregate data from the Internet (illustrated in FIG. 4B). This embodiment 400 of the system 100 takes as input a data source consisting of cybersecurity events across multiple companies, the associated industry vertical associated with the victim of the attacks (i.e. identifiable by NAICS code), a list of software vulnerabilities exploited by hackers or otherwise used in the attacks, and the date of the attack. As an alternative, lists of vulnerabilities across multiple companies within an industry vertical could also be used (i.e. from a vulnerability scanner or a service provider that served multiple firms across multiple verticals). From this information, over the course of a period of time (i.e. 1 year), for a given industry vertical, the system 100 would produce a list of software vulnerabilities used against firms (i.e. identifiable by NIST CVE numbers, for instance) within that industry vertical as well as the associated software or hardware (i.e. identifiable by NIST CPE numbers, for instance) relating to the vulnerability.

An example of this embodiment 400 is similar to embodiment 300 except that rather than assuming the existence of database D, a similar database D 402 may be created through web-scraping technology concerning software running in various organizations. In such a scheme, web crawlers and parsers would be created for various data sources and the results of the crawling are stored in the database 402 established under a common schema

It may be the case that some of the data collected will be listed by Categories (i.e. industry vertical) directly as opposed to Organizations. If data is collected in this manner, then for each category, for a given category C, set T(C(D)) described above is created directly based on category C as opposed to created based on a set of organizations (set C(D)).

In another sub-embodiment 500 of embodiment 400 (e.g., an embodiment 500 considered to be an optional addition or variation to embodiment 400), the system 100 considers sets of exemplary technology configurations such as exemplary technology stacks (ETSs) across multiple industry verticals to apply analysis of cyber threats to a portfolio of software and/or hardware platforms. For example, given a portfolio of companies, this system may take as input information about how many companies in the portfolio belong to each industry vertical. The embodiment 500 of the system 100 would then produce ETSs (either pre-computed or computed on the fly) leveraging functionality and features of the aforementioned embodiments of FIGS. 3A-3B and 4A-4B. It is noteworthy that the computation of ETSs can change overtime, so it is important that the embodiment 500 of the system 100 compute the most up-to-date ETSs based on the time of the input. The system 100 under the embodiment 500 is further operable to take the vulnerabilities associated with each ETS and map those to threats from one or more sources of cyber threat intelligence—information collected about adversaries affecting vulnerabilities and/or specific pieces of software. Ideally, such threat intelligence would be augmented with quantified predictions about the various threats taking an action (i.e. an attack) however such augmentation is not strictly necessary for the embodiment 500 of the system 100. The output of this embodiment 500 of the system 100 may include a graphical relationship model as depicted in FIG. 4A. Leveraging the computing device 102, the embodiment 500 of the system 100 may further generate a machine readable version of such a model (to then be used for further analysis by automated means, such as graph algorithms, advanced queries, machine learning, artificial intelligence, or statistical methods) and/or a visual display (i.e. via user interface or thru an automatically generated report)—such a visual display may be used for further analysis to support various decisions relating to cyber security.

To further illustrate by example, in this embodiment 500, suppose we have a portfolio or organizations P. For each organization O in P, we have an associated category, c(P). Produced by the embodiment 300 or the embodiment 400 of the system 100, fora given category C, we access/generate an associated Exemplar Technology Configuration e(C).

Using other technology, such as CYR3CON's OEM offering (https://www.cyr3con.ai/oem), each technology in e(C) can then be mapped to a quantified prediction of a cyber threat relating to vulnerabilities in that software (i.e. release of an exploit).

Turning to FIG. 4C, some of the data sets mentioned above and their transformations into different data sets or records by computing device 102, are illustrated with exemplary values. In some embodiments, the data set transformations illustrated using the exemplary values shown in FIG. 4C are performed by filtering and preprocessing services 130A and mapping service 130B (sometimes referred to collectively as services 130, for simplicity), both of which are stored in memory 106 and execute on processor 104 as described in connection with FIG. 1.

In the first column 410 of FIG. 4C, operational input data retrieved by services 130 are illustrated. These data include exemplary technology configurations 412, similar to configurations 342 shown in FIG. 3C. As mentioned above, the exemplary technology configurations are mappings between an industry vertical category or classification, and the representative software and/or hardware vulnerabilities determined on the basis of historical cybersecurity event data. Referencing the notation introduced above, the exemplary technology configurations for a given category are represented as e(C).

Below the exemplary technology configurations 412 illustrated by FIG. 4C, vulnerabilities 414 predicted to affect a subject technology configuration are shown. These may include a list of software vulnerabilities (identifiable by the National Institute of Standards and Technology (NIST) common vulnerability enumeration (CVE) numbers) or hardware vulnerabilities (not shown in the exemplary values, but identifiable by NIST common platform enumeration (CPE) numbers, for instance) relating to threats or attacks against the subject technology configuration predicted by the computing device 102.

The second column 420 of FIG. 4C illustrates metadata-augmented predicted vulnerability data 422 produced by adding metadata specifying software/hardware configurations to the list of vulnerabilities 414 predicted to affect the subject technology configuration. The third column 430 of FIG. 4C illustrates the merging of the predicted vulnerabilities with the augmented metadata to produce a threat map 432 that maps predicted threats to the affected/vulnerable hardware and/or software configurations.

FIG. 4D illustrates a simplified block diagram of a possible computer-implemented method of creating threat maps. Process 450 can be performed by computing device 102, namely by services 130 stored on memory 106 and executed by processor 104. Process 450 includes step 452, where computer 102 retrieves exemplary technology configurations 412, sometimes represented as e(C) for industry vertical categories or classifications C. Exemplary technology configurations 412 may be similar to the exemplary technology configurations 342 shown in FIG. 3C, whose generation is described in connection with process 350 of FIG. 3D.

Process 450 further includes step 454, where predictive threat data specifying vulnerabilities 414 anticipated to be targeted in a cybersecurity attack are retrieved. Vulnerabilities 414 may be identified by a machine learning model trained on historical attack data and exemplary technology stacks (ETSs) that enable the prediction of future attacks over a given period of time for a particular exemplary technology stack (e.g., exemplary technology configurations 412). Each of the vulnerabilities 414 may be associated with a respective vulnerability identifier (e.g., a CVE/CPE number).

Process 450 further includes step 456, where predictive threat data such as vulnerabilities 414 are augmented with metadata specifying vulnerable hardware and/or software stacks. As mentioned above, vulnerabilities 414 may be associated with a CVE or CPE number. At step 456, vulnerabilities 414 associated with a particular CVE number may be augmented with metadata specifying the name or other details of actual vulnerable software or software configurations associated with the particular CVE number. Similarly, vulnerabilities 414 associated with a particular CPE number may be augmented with metadata specifying the name or other details of actual vulnerable hardware or hardware configurations associated with the particular CPE number. Augmenting the vulnerabilities 414 with the metadata specifying actual configurations associated with the CVE/CPE numbers for each vulnerability produces metadata-augmented vulnerability data 422.

Process 450 further includes step 458, where metadata-augmented vulnerability data 422 is joined with vulnerabilities 414 to create a threat map 432 that maps predicted threats to the actual software and/or hardware configurations associated with the CVE/CPE numbers for each vulnerability 414 of the predictive threat data.

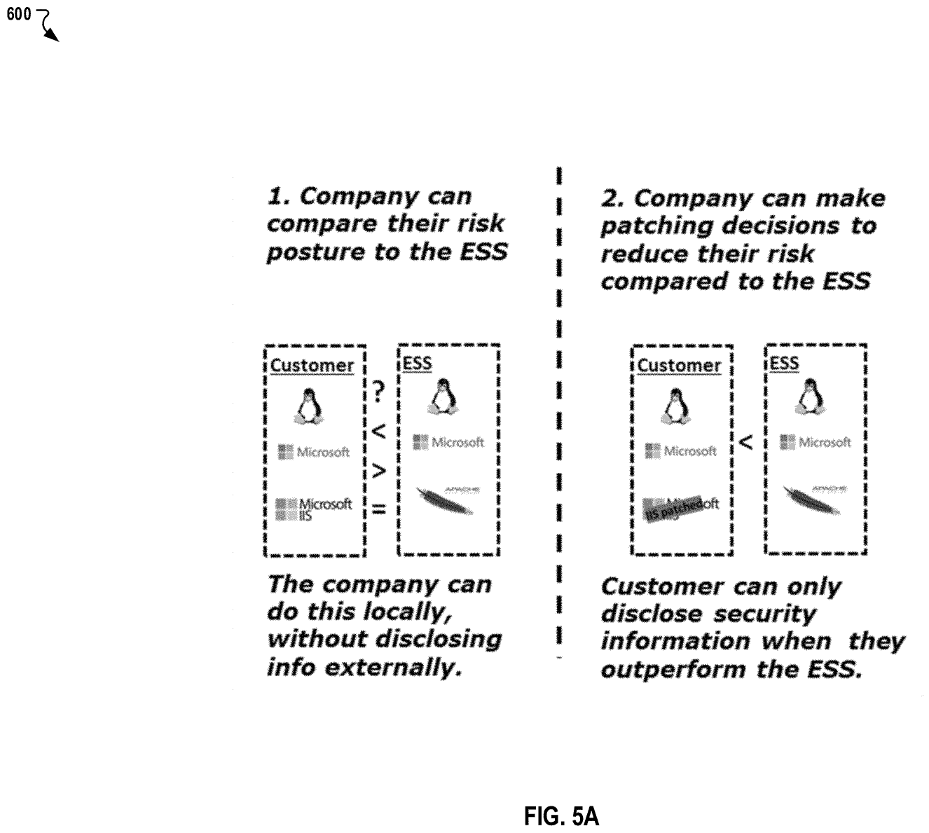

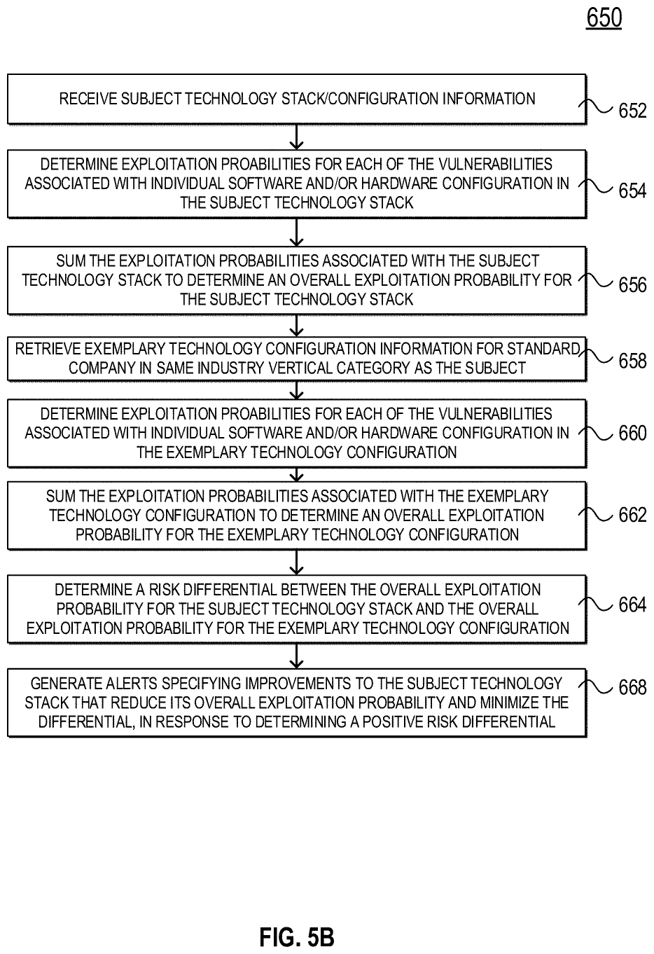

In another embodiment 600 shown in FIG. 5A, the system 100 compares the risk of a single subject technology platform (associated with e.g., a company) to an exemplary technology configuration (e.g., ETS) to understand differential risk. For example, an individual company can identify the software they run within the organization and compare it to an ETS (i.e. recently created by an embodiment of the system 100 such as the embodiment 300 and embodiment 400). This can allow for a comparison with the ETS to understand the differential in risk between the company and its associated industry vertical. Intuitively, this allows the company to understand if their risk posture is better or worse than what is expected for a firm within their industry vertical. The comparison between a company's installed software (or hardware, or hardware-software combination) and the ETS (or technology configuration including hardware and/or software) can be based on one or more factors.
a. In an example of this embodiment, a given organization can take an inventory of software and/or vulnerabilities from their environment (i.e. produced using software such as Qualys or Rapid7) and then associate it with quantified threats such as CYR3CON's OEM offering (https://www.cyr3con.ai/oem). For example, let V be a list of vulnerabilities and for each v in V, let thrt(v) be the probability of exploitation.
b. Then, the same organization can take an assessment of their associated category as described herein. Let us call the list of vulnerabilities for a standard company in the category V′. So, to compare the two, we can take the sum of all values thrt(v′) for each v′ in V′ and compare that to the sum of all values thrt(v) for each v in V. This can provide a differential.

For example:
The number and type of vulnerabilities present in the company's software when compared with those present in the ETS
Using threat intelligence sources, the types of threats directed against the company's software and/or vulnerabilities compared with the threats directed toward the software and/or vulnerabilities in the ETS
Using quantifiable techniques (to include predictive techniques such as machine learning) comparing a quantified metric of risk associated with the company to that of the ETS.

Turning to FIG. 5B, a simplified block diagram of a possible computer-implemented process 650 or method of generating actionable alerts for a customer that improve the threat resilience or lower the exploitation probability of a subject technology stack/configuration under evaluation.

Process 650 begins at step 652, where services 130 (e.g., risk comparison service 130C) executing at computing device 102 receive subject technology stack/configuration information. Subject technology stack/configuration information includes information about the specific software and/or hardware configurations used in the subject technology stack, as well as the specific vulnerabilities associated with the specific software and/or hardware configurations.

Process 650 continues to step 654, where exploitation probabilities associated with each of the specific vulnerabilities in the subject technology stack/configuration information are assessed or otherwise determined. Each exploitation probability represents a probability that its associated vulnerability in the subject technology stack/configuration will be exploited within a certain time period (e.g., 1 month, 1 year, 2 years, etc.) and can be based on historical data or a machine learning model used to predict threats to the specific software and/or hardware used in the subject technology stack/configuration. At step 656, these exploitation probabilities are summed to determine an overall exploitation probability for the subject technology stack/configuration. The overall exploitation probability represents a probability that any of the vulnerabilities associated with the subject technology stack/configuration will be exploited within a certain time period (e.g., 1 month, 1 year, 2 years, etc.).

Process 650 continues to step 658, where exemplary technology configuration information for a generic or standard company in the same industry vertical category as the subject technology stack/configuration is retrieved or otherwise determined by computing device 102. Using the above referenced notation, the exemplary technology configuration for industry vertical classification or category C is represented by e(C).

Process 650 continues to step 660, where exploitation probabilities associated with each of the specific vulnerabilities in the exemplary technology stack/configuration information e(C) are assessed or otherwise determined. Each exploitation probability represents a probability that its associated vulnerability in the exemplary technology stack/configuration will be exploited within a certain time period (e.g., 1 month, 1 year, 2 years, etc.) and can be based on historical data or a machine learning model used to predict threats to the specific software and/or hardware used in the exemplary technology stack/configuration. At step 662, these exploitation probabilities are summed to determine an overall exploitation probability for the exemplary technology stack/configuration, e(C). The overall exploitation probability represents a probability that any of the vulnerabilities associated with the exemplary technology stack/configuration will be exploited within a certain time period (e.g., 1 month, 1 year, 2 years, etc.).

Process 650 continues to step 664, where a risk differential between the overall exploitation probability for the subject technology stack/configuration and the overall exploitation probability for the exemplary technology stack/configuration e(C). The risk differential provides a quantified measure or metric of how much additional risk the subject technology stack/configuration is exposed to on account of its specific vulnerabilities, relative to a risk level (e.g., the overall exploitation probability) that the exemplary technology stack/configuration e(C) is exposed to.

Process 550 continues to step 668, where alerts are generated in response to determining a positive risk differential in step 664. A positive risk differential indicates an increased risk of exploitation in the subject technology stack/configuration relative to an exemplary technology stack/configuration e(C). The alerts generated at step 668 specify improvements (e.g., patches, hardening operations, or other counter-measures to cyber threats) that can reduce the overall exploitation probability for the subject technology stack/configuration to a level that is equal to or below the overall exploitation probability for the exemplary technology stack/configuration (e.g., minimize the risk differential calculated at step 564).

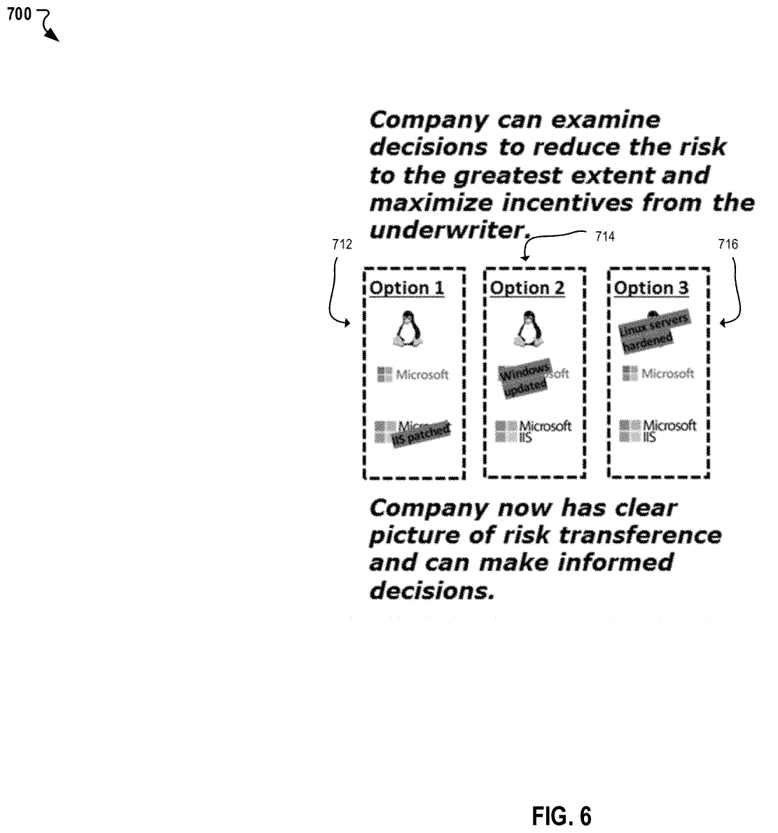

In another embodiment 700 shown in FIG. 6, the system 100 is configured for risk reduction based on a comparison between the risk differential between a subject technology platform and an ETS. The risk differential may be a quantified metric for a degree of increased risk in a subject technology stack/configuration relative to the risk present in an exemplary technology stack/configuration for a company in the same industry vertical classification as the company using the subject technology stack/configuration. For example, this embodiment 700 takes the results of a comparison between a company's software and that associated with an ETS using the embodiments 300 and 400 in order to allow the company to reduce their risk below that associated with the ETS. Such an embodiment 700 can use computation techniques (i.e. combinatorial optimization) or a user interface executed by the computing device 102 to allow an analyst to enact various scenarios to determine which would be ideal for meeting their information technology needs while reducing risk relative to the ETS to the greatest extent possible. It is important for the company to be able to consider various options for reducing risk, such as that depicted in FIG. 6. A first option 712 can have a first overall exploitation probability that accounts for the reduced vulnerability to the Microsoft IIS configuration due to IIS patch applied in the stack/configuration associated with option 712. A second option 714 can have a second overall exploitation probability that accounts for the reduced vulnerability to the Microsoft Operating System configuration due to updates applied in the stack/configuration associated with option 714. A third option 716 can have a third overall exploitation probability that accounts for the reduced vulnerability to the Linux configuration due to server hardening operations undertaken in the stack/configuration associated with option 716.

In another embodiment (not shown), the system 100 is configured to predict an expected number of attacks over a given predetermined time period based on software configurations. For example, the system 100 takes as input a set of (one or more) ETSs associated with a given group (consisting of one or more) and predicts the expected number of attacks over a period of time (i.e. 1 year). This system then uses a machine learning model—trained on a historical corpus of attack data (and associated ETSs) that enable the prediction of the expected number of attacks over a given period of time (i.e. 1 year) for a new ETS. It is noteworthy that an ETS can change over time, so that the ETSs used for the historical training may be different from the ETSs used as input for the prediction. This is acceptable as such a machine learning model (executed by the computing device 102 or otherwise implemented) would extract features either directly from the ETS and/or augmented through additional data (i.e. threat intelligence). Further, a prediction can also be made based on the specific software configuration of a specific company (in other words, not using the ETS) in order to predict expected attacks for that specific company.

In another embodiment (not shown), the system 100 is configured for transferring risk based on the differential between a given technology platform and an associated ETS. In this system, the input consists of the output of a system to compare the risk of an individual company with an ETS and use those results to understand risk transfer. For example, if a company makes or does not make a security decision that affects the differential in risk compared with the ETS, an owner of a portfolio can the make a decision as to if these decisions lead to an increase or decrease of the risk to their portfolio and then make appropriate decisions. Such an embodiment of the system 100 would use a model implemented by the computing device 102 to associate level of risk (ideally quantified as a vector or scalar) with costs/benefits with an associated monetary value. In this way, the cost of taking or not taking certain security actions can then be associated with monetary costs assumed by the portfolio owner, and the individual company can be incentivized/dis-incentivized in a manner to encourage or discourage various security behaviors.

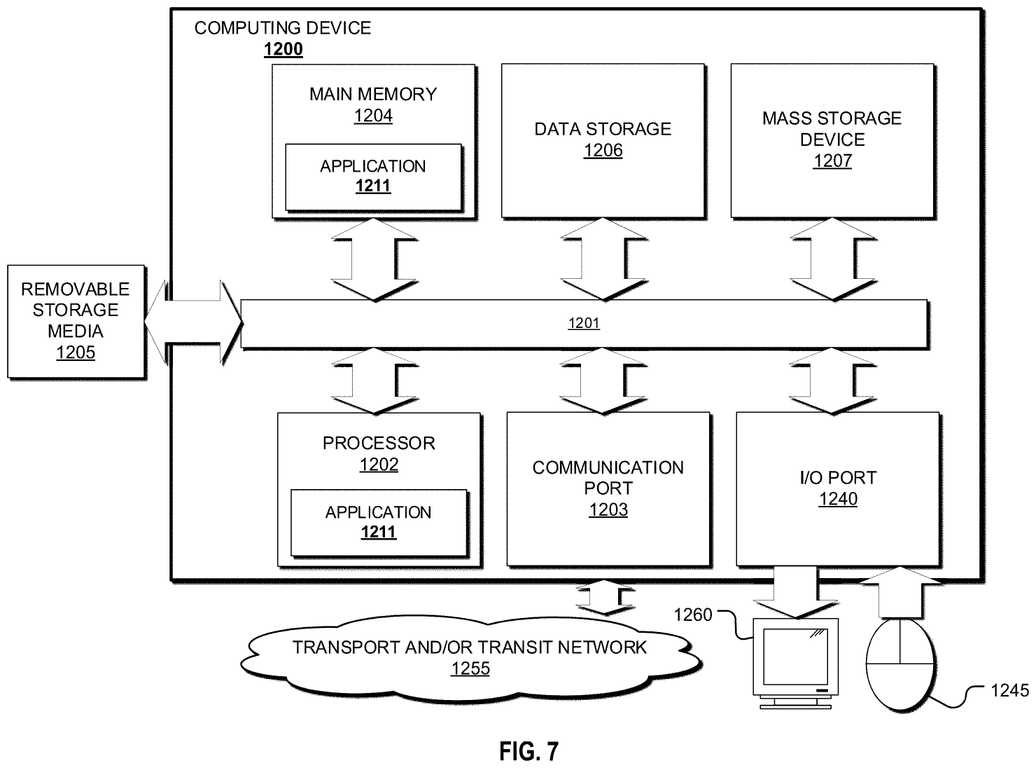

Referring to FIG. 7, a computing device 1200 is illustrated which may take the place of either of the computing device 102 or other computing devices described herein and be configured, via one or more of an application 1211 or computer-executable instructions, to execute cyber risk transfer functionality described herein. More particularly, in some embodiments, aspects of the predictive methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method of vulnerability-based cyber risk transfer for improved cyber security, comprising:
preprocessing a dataset accessed from a network to extract operational input data, the operational input data defining
a plurality of cyber-attacks with each of the plurality of cyber-attacks applied to a respective company of a plurality of companies,
vulnerabilities exploited for each of the set of cyber-attacks, and
an industry vertical identifier associated with each company of the plurality of companies;
augmenting, by the processor, the operational input data with metadata;
generating, by the processor, a first intermediate mapping of the vulnerabilities to each of the plurality of companies;
generating, by the processor, a second intermediate mapping of an industry vertical comprising one or more of the plurality of companies to at least one of the vulnerabilities leveraging the industry vertical identifier;
generating by the processor and storing within a database for subsequent application an exemplary technology configuration, the exemplary technology configuration mapping the industry vertical to exemplary hardware or software configurations; and
identifying by the processor, a possibly vulnerability to a subject technology configuration associated with the industry vertical by confirming at least one commonality between the exemplary hardware and software configurations and hardware and software configurations of the subject technology configuration.

2. The method of claim 1, further comprising applying artificial intelligence by the processor to preprocess the dataset and extract a plurality of parameters from the dataset, at least a portion of the plurality of parameters defining the operational input data.

3. The method of claim 2, further comprising aggregating the plurality of parameters by searching for web information where the plurality of parameters have been disclosed or logged in social media, public disclosures, or developer platforms.

4. The method of claim 1, further comprising:
generating, by the processor, a plurality of exemplary technology configurations for each of a plurality of respective industry verticals; and
comparing the plurality of exemplary technology configurations to analyze threat risk across multiple industry verticals.

5. The method of claim 1, further comprising identifying by the processor, by cross referencing records of the database with information about software implemented by the subject technology configuration, a known vulnerability from the exemplary technology configuration susceptible to the subject technology configuration.

6. The method of claim 1, further comprising:
generating, by the processor, a plurality of exemplary technology configurations for each of a plurality of respective industry verticals;
identifying, by the processor analyzing the dataset, a pattern from known vulnerabilities of the exemplary technology configuration; and
predicting by the processor in view of the pattern an increase in cyber-attacks over a given time period based on the exemplary technology configuration.

7. The method of claim 1, wherein the exemplary technology configuration includes software and/or hardware components, such that the possible vulnerability relates to a software vulnerability or a hardware vulnerability.

8. The method of claim 1, further comprising recommending, by the processor, a modification to the subject technology platform to reduce risk of an identified vulnerability to the subject technology based on a software component common to both of the subject technology configuration and the exemplary technology configuration.

9. The method of claim 8, further comprising predicting, by the processor, an outcome of the possible vulnerability based on a software component common to the subject technology platform and the exemplary technology configuration, the outcome defining whether the modification to the subject technology platform was implemented or was not implemented.

10. A tangible, non-transitory, computer-readable media having instructions encoded thereon, the instructions, when executed by a processor, are operable to:
access, by a processor, a dataset including information about cyber events and technology vulnerabilities exploited for the cyber events;
map, by the processor, a plurality of exemplary technology configurations susceptible to a given technology vulnerability of the technology vulnerabilities;
identify, by the processor, parameters of a subject technology configuration; and
identify, by the processor, a possible vulnerability of the subject technology configuration by matching a software component implemented by the subject technology configuration with a corresponding software component implemented by one of the plurality of exemplary technology configurations.

11. The tangible, non-transitory, computer-readable media of claim 10, comprising additional instructions that, when executed by the processor, are operable to:
access vulnerability mappings associated with the identified parameters of the subject technology configuration; and
assess one or more probabilities of exploitation associated with the vulnerability mappings.

12. The tangible, non-transitory, computer-readable media of claim 11, comprising additional instructions that, when executed by a processor, are operable to:
determine an overall exploitation probability associated with the subject technology configuration, based on the one or more probabilities of exploitation.

13. The tangible, non-transitory, computer-readable media of claim 12, comprising additional instructions that, when executed by a processor, are operable to:
assessing probability of exploitation associated with the given technology vulnerability mapped to the plurality of exemplary technology configurations;
assessing additional probabilities of exploitation associated with additional technology vulnerabilities for the selected exemplary technology configuration; and
determine an overall exploitation probability associated with a selected one of the plurality of exemplary technology configurations, by adding the probability of exploitation associated with the given technology vulnerability to the additional probabilities of exploitation associated with the additional technology vulnerabilities.

14. The tangible, non-transitory, computer-readable media of claim 13, comprising additional instructions that, when executed by a processor, are operable to:
calculate a risk differential indicating a degree of increased exploitation risk of the subject technology configuration relative to at least one of the plurality of exemplary technology configurations, by subtracting the overall exploitation probability of the subject technology configuration from the overall exploitation probability of the at least one of the plurality of exemplary technology configurations.

15. The tangible, non-transitory, computer-readable media of claim 13, comprising additional instructions that, when executed by a processor, are operable to:
determine that the risk differential is positive, indicating that the subject technology configuration has a greater chance of being exploited than the at least one of the subject technology configurations; and
generate alerts specifying changes to the identified parameters of the subject technology configuration to improve the threat resiliency of the subject technology configuration, in response to determining that the risk differential is positive.

16. A device for vulnerability-based risk transfer in cyber security, comprising:
a processor;
a network interface in operable communication with the processor, the network interface operable for communicating with a network to enable the processor to access data about cyber events; and
a memory storing a set of instructions executable by the processor, the set of instructions, when executed by the processor, operable to:
access, by a processor, a dataset including information about cyber events and vulnerabilities exploited for the cyber events;
map, by the processor, a plurality of exemplary technology configurations to respective technology vulnerabilities, each of the plurality of exemplary technology configurations corresponding to a particular industry vertical;
identify, by the processor, attributes of a subject technology configuration defining specific software components implemented by the subject technology configuration; and
identify, by the processor, a possible vulnerability of the subject technology configuration by cross referencing technology vulnerabilities of at least of the exemplary technology configurations with the attributes of the subject technology.

17. The device of claim 16, wherein, based on further instructions stored by the memory, the processor is further operable to:
calculate a risk differential indicating a degree of increased exploitation risk of the subject technology configuration relative to the at least one of the plurality of exemplary technology configurations, by subtracting an overall exploitation probability of the subject technology configuration from an overall exploitation probability of the at least one of the plurality of exemplary technology configurations.
